(19) United States
(12) Patent Application Publication
(10) Pub. No.: US 2014/0098951 A1
(43) Pub. Date: Apr. 10, 2014

(54) METHOD FOR ELLIPTIC CURVE CRYPTOGRAPHY WITH COUNTERMEASURES AGAINST SIMPLE POWER ANALYSIS AND FAULT INJECTION ANALYSIS AND SYSTEM THEREOF

(71) Applicant: ELECTRONICS & TELECOMMUNICATIONS RESEARCH INSTITUT, Daejeon (KR)

(72) Inventors: Yong Je CHOI, Daejeon (KR); Doo Ho CHOI, Chungcheongnam-do (KR); Hyun Sook CHO, Daejeon (KR)

(73) Assignee: ELECTRONICS & TELECOMMUNICATIONS RESEARCH INSTITUTE, Daejeon (KR)

(21) Appl. No.: 13/770,006

(22) Filed: Feb. 19, 2013

(30) Foreign Application Priority Data
Oct. 5, 2012 (KR) 10-2012-0110726

(51) Int. Cl. H04L 9/28

(52) U.S. Cl. CPC H04L 9/28
USPC 380/28

(57) ABSTRACT

There are provided a method for elliptic curve cryptography with countermeasures against simple power analysis and fault injection analysis, and a system thereof. According to an aspect, there is provided a method for elliptic curve cryptography, in which an elliptic curve point operation is performed to generate an elliptic curve code, including: receiving a first point and a second point on the elliptic curve, wherein the first point is P₀=(x₀, y₀) and the second point is P₁=(x₁, y₁); and performing doubling if the first point is the same as the second point, and performing addition if the first point is different from the second point, to thereby obtain a third point, wherein the third point is P₂=P₀+P₁=(x₂, y₂). Accordingly, it is possible to provide countermeasures against a side channel analysis attack.

### CLAIM FOR PRIORITY

This application claims priority to Korean Patent Application No. 10-2012-0110726 filed on Oct. 5, 2012 in the Korean Intellectual Property Office (KIPO), the entire contents of which are hereby incorporated by reference.

### BACKGROUND

1. Technical Field

An example embodiment of the present invention relates in general to elliptic curve cryptography, and more specifically, to a method for elliptic curve cryptography with countermeasures against simple power analysis and fault injection analysis, and a system thereof.

2. Related Art

Elliptic curve cryptography is a public key encryption method based on an elliptic curve theory, and was been proposed independently by N. Koblitz and V. Miller in 1985.

An elliptic curve itself has been usefully used in determination of prime numbers, factorization in prime factors, etc. in mathematics. Elliptic curve cryptography, which is abbreviated as ECC, is based on a discrete logarithm problem in an elliptic curve group defined on a finite field. An apparatus or system to which the elliptic curve cryptography has been applied is called an elliptic curve cryptosystem.

A representative advantage of the elliptic curve cryptosystem compared to Rivest-Shamir-Adleman (RSA) and El Gamal Scheme systems is that the elliptic curve cryptosystem provides a security level similar to that provided by the RSA and El Gamal Scheme system while using a shorter key size.

In detail, for example, an elliptic curve cryptosystem can use 160 bits to provide the same security level as an RSA system using 1024 bits. Accordingly, the elliptic curve cryptosystem can be usefully used for smart cards or wireless communication having a limitation in storage capacity and bandwidth. Also, the elliptic curve cryptosystem can be applied to most systems using existing public key encryption methods based on the discrete logarithm problem.

In other words, the elliptic curve cryptography can be implemented with a small area in resource-constrained devices, and transmits a significantly smaller amount of data compared to the RSA and El Gamal Scheme. Also, the elliptic curve cryptography is robust to high-dimensional side channel analysis such as differential power analysis.

However, when the elliptic curve cryptosystem is used, secret information which has been not considered upon designing an encryption algorithm may be leaked. Particularly, since operations with respect to a secret key are often performed when a smart card operates, leakage of secret information may greatly influence the security of the elliptic curve cryptosystem.

Kelsey has defined such leakage of secret information as a side channel in his paper, and also defined an attack using such a side channel as a side channel attack. Side channel attacks can be classified into timing attacks, fault insertion attacks, power analysis attacks, etc. Power analysis attacks can be classified into simple power analysis attacks and differential power analysis attacks.

In a timing attack, the execution time of an algorithm is analyzed to attack an elliptic curve cryptosystem. In a fault insertion attack, an encryption system is implemented, and then an attack is attempted with an optical fault insertion method using a laser beam and flash and the result is analyzed. In a power analysis attack, the amount of power consumption when an encryption system is implemented is analyzed to attack the encryption system.

Hereinafter, a conventional side channel analysis apparatus will be described with reference to FIG. 1.

Referring to FIG. 1, the conventional side channel analysis apparatus includes a leakage information collecting unit 120 such as an oscilloscope for collecting a plurality of pieces of repeated leakage information from a target device 110 to be analyzed, and a computing unit 130 for receiving the collected leakage information from the leakage information collecting unit 120 and performing side channel analysis.

The side channel analysis apparatus performs operations of successively collecting the waveforms of leakage information using the oscilloscope, etc. and storing the collected waveform data in the computing unit, of processing the collected waveform data at the computing unit such that the waveform data can be subject to side channel analysis, and of performing analysis to acquire secret information from the processed waveform data, wherein the operations are sequentially performed.

In the operation of processing the waveform data, the waveform data is individually processed, and in the operation of performing analysis, the entire waveforms are integrally analyzed.

Meanwhile, in elliptic curve cryptography, keys may be easily leaked by simple power analysis based on the difference between elliptic curve point addition and elliptic curve point doubling even though elliptic curve cryptography is robust to high-dimensional side channel analysis such as differential power analysis. This is because elliptic curve point addition and elliptic curve point doubling make a difference in computation quantity according to key bits, so that they are easily observed as different changes in waveform upon simple power analysis.

Although many algorithms have been proposed in order to overcome this problem, such algorithms require many additional logics and operations.

Accordingly, the design of an elliptic curve cryptosystem for providing a countermeasure against a side channel attack becomes complicated, and its manufacturing cost also increases.

### SUMMARY

Accordingly, example embodiments of the present invention are provided to substantially obviate one or more problems due to limitations and disadvantages of the related art.

An example embodiment of the present invention provides a method for elliptic curve cryptography (ECC) with countermeasures against simple power analysis by making the computation quantity of addition equal to the computation quantity of doubling.

An example embodiment of the present invention also provides a system for elliptic curve cryptography (ECC) with countermeasures against fault injection analysis by removing a dummy operation upon elliptic curve point operations.

In an example embodiment, there is provided a method for elliptic curve cryptography, in which an elliptic curve point operation is performed to generate an elliptic curve code, including: receiving a first point and a second point on the elliptic curve, wherein the first point is P₀=(x₀, y₀) and the second point is P₁=(x₁, y₁); and performing doubling if the first point is the same as the second point, and performing addition if the first point is different from the second point, to thereby obtain a third point, wherein the third point is P₂=P₀+P₁=(x₂, y₂).

A computation quantity of the doubling may be equal to a computation quantity of the addition.

A dummy operation supporting an actual operation may be removed from the doubling and the addition.

x₂=λ²−(x₀+y₀) and y₂=λ(x₀−x₂)−y₀ when the doubling is performed, and x₂=λ²−(x₀+x₁) and y₂=λ(x₀−x₂)−y₀ when the addition is performed.

In the doubling and the addition, λ may be obtained by one multiplication, a threefold multiplication (×3), and one addition or one subtraction.

λ may be (3(x₀*x₀)+a)/(y₀+y₀) if the doubling is performed, and λ may be (3((⅓)*y₁)−y₀)/(x₁−x₀) if the addition is performed.

In λ of the addition, ⅓ may be a value calculated in a preceding operation and stored in advance.

In another example embodiment, there is provided a system for elliptic curve cryptography, which performs an elliptic curve point operation to generate an elliptic curve code, including: a memory configured to store a program code for performing an elliptic curve cryptography algorithm; and a processor configured to load and use the program code to obtain a third point corresponding to a received first point and a received second point, wherein the first point is P₀−(x₀, y₀), the second point is P₁=(x₁, y₁), and the third point is P₂=P₀+P₁=(x₂, y₂); and wherein the elliptic curve cryptography algorithm is configured to perform doubling if the first point is the same as the second point, and performs addition if the first point is different from the second point, to thereby obtain the third point.

A computation quantity of the doubling may be equal to a computation quantity of the addition.

A dummy operation supporting an actual operation may be removed from the doubling and the addition.

x₂=λ²−(x₀+y₀) and y₂=λ(x₀−x₂)−y₀ when the doubling is performed, and x₂=λ²−(x₀+x₁) and y₂=λ(x₀−x₂)−y₀ when the addition is performed.

In the doubling and the addition, λ may be obtained by one multiplication, a threefold multiplication (×3), and one addition or one subtraction.

λ may be (3(x₀*x₀)+a)/(y₀+y₀) if the doubling is performed, and λ may be (3((⅓)*y₁)−y₀)/(x₁−x₀) if the addition is performed.

In λ of the addition, ⅓ may be a value calculated in a preceding operation and stored in advance.

Therefore, according to the method for elliptic curve cryptography, it is possible to provide a countermeasure against simple power analysis by making the computation quantity of addition equal to the computation quantity of doubling.

Also, according to the system for elliptic curve cryptography, it is possible to provide a countermeasure against fault injection analysis by removing a dummy operation from an elliptic curve point operation.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view for explaining the configuration of a conventional side channel analysis apparatus;

FIG. 2 is an example of a first algorithm for a point operation, and shows point addition and point doubling;

FIG. 3 is an example of a second algorithm, which is a countermeasure against simple power analysis, and shows a binary operation for scalar multiplication; and

FIG. 4 is an example of a third algorithm for elliptic curve cryptography (ECC), according to an embodiment of the present invention.

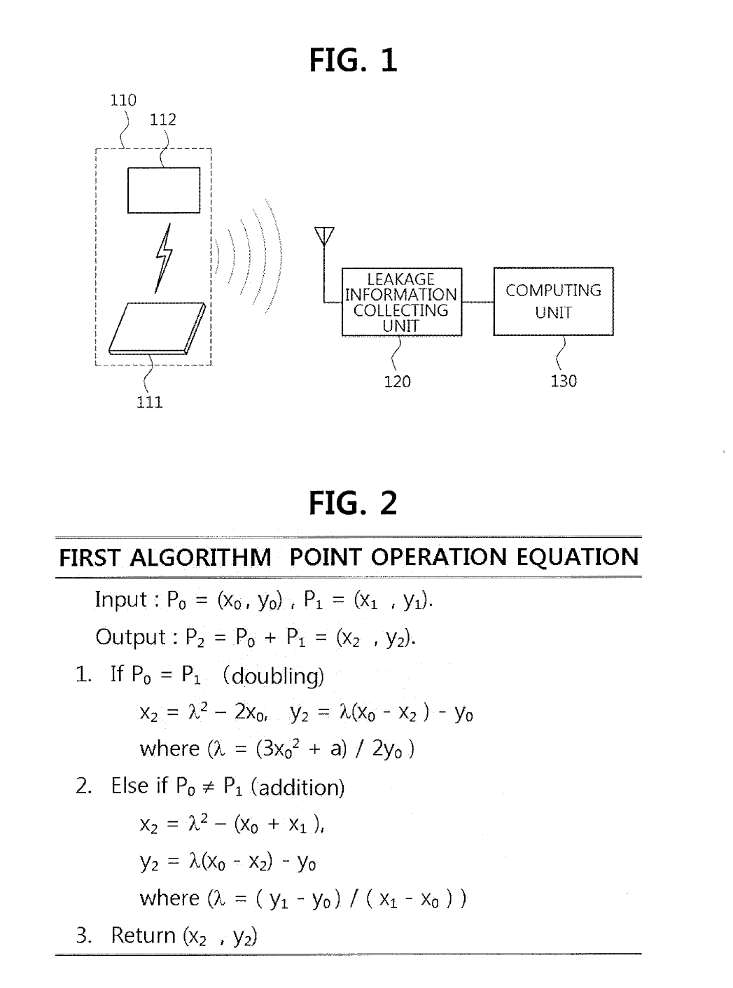

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings.

In a method for elliptic curve cryptography (ECC) according to an embodiment of the present invention, an algorithm is designed such that the computation quantity of elliptic curve point addition is equal to the computation quantity of elliptic curve point doubling in order to provide countermeasures against simple power analysis and fault injection analysis.

Elliptic curve cryptography is a public key encryption method based on an elliptic curve theory, and has been made based on an elliptic curve discrete logarithm problem (ECDLP) whose solution has been known to be not easily obtained in a finite field.

An elliptic curve is described in more detail, below.

An elliptic curve E(K) defined on a base field K includes a group of points (x, y) that are solutions satisfying the Karl Weierstrass equation expressed in Equation 1, and a group of points at infinity O.

y²+a, xy+a₃y=x³+a₂x²+a₄x+a₆ [Equation 1]

where aᵢ ∈ K, and each point (x, y) satisfying Equation 1 should be non-singular.

The base field K may be represented as a finite field GF(p) for a prime number p.

If p≠2 or 3, the elliptic curve E(K) is expressed by Equation 2, below.

y²=x³+ax+b [Equation 2]

Meanwhile, if p=2, the elliptic curve E(K) is expressed by Equation 3, below.

y²+xy=x³+ax²+b [Equation 3]

In this case, the elliptic curve E(K) includes points at infinity O that satisfy none of Equations 1, 2, and 3, in addition to the points (x, y) satisfying Equations 1, 2, and 3. The points at infinity O act as identity elements with respect to addition upon an elliptic curve point operation.

That is, the elliptic curve E can be rewritten as Equation 4, below.

E={(x, y)|x, y ∈ R, y²+a, xy+a₃y=x³+a₂x²+a₄x+a₆} U {O} [Equation 4]

As such, the group of points on the elliptic curve E(K) and the points at infinity O form a commutative group with respect to addition. The commutative group is a group in which the commutative law always holds with respect to two arbitrary elements.

In other words, an elliptic curve E(K) on a space is composed of points (x, y), and is in the shape of an elliptic curve expressed in the relationship between x and y coordinates.

The ECDLP mentioned above means that when a value Q obtained by multiplying an arbitrary point P on an elliptic curve by an integer k is Q=kP, it is difficult to calculate the integer k even when the points Q and P are given. Accordingly, the key operation of the elliptic curve cryptosystem is to obtain scalar multiplication, that is, Q=kP. The scalar multiplication most greatly influences the security and efficiency of the elliptic curve cryptosystem.

An operation for scalar multiplication is performed by repeatedly using doubling of summing the same two points and addition of summing two different points.

Hereinafter, a point operation will be described with reference to FIG. 2.

FIG. 2 is an example of a first algorithm for a point operation, and shows point addition and point doubling.

First, if p≠2 or 3 in GF(p), it is defined that a point on an elliptic curve is defined as P₀=(x₀, y₀)≠0, the inverse element of P₀ is defined as −P₀=(x₀, −y₀), and another point on the elliptic curve is defined as P₁=(x₁, y₁)≠0. Also, a sum of P₀ and P₁ is defined as P₂=(x₂, y₂).

In other words, input values are P₀=(x₀, y₀) and P₁=(x₁, y₁), and an output value is P₂=P₀+P₁=(x₂, y₂).

If P₀=P₁, x₂ and y₂ are given the following values through point doubling.

x₂=λ²−2x₀, and y₂=λ(x₀−x₂)−y₀, wherein λ=(3x₀²+a)/2y₀.

If P₀≠P₁, x₂ and y₂ are given the following values through point addition.

x₂=λ²−(x₀+x₁), and y₂=λ(x₀−x₂)−y₀, wherein λ=(y₁−y₀)/(x₁−x₀).

However, the point doubling and addition of the elliptic curve are easily exposed to a simple power analysis attack due to different power waveforms that appear when an elliptic curve cryptosystem is driven. Accordingly, the secret key of elliptic curve encryption is leaked.

In more detail, a power analysis attack is an attack method of finding secret information by measuring and analyzing consumption power among side channel information that is generated when a device such as a smart card is driven. The attack method was proposed by Paul Kocher (see Crypto' 99) who has applied it to DES, and is greatly classified into two methods, as follows.

One is simple power analysis (SPA) of extracting the characteristics of consumption power signals when an operation regarding a secret key in a smart card is performed to find information about the secret key, and the other is differential power analysis (DPA) of combining the statistical analysis of the SPA with error correction.

SPA is an attack method of finding an internal secret key by recognizing the characteristics of instructions that are performed according to the secret key in a smart card and back-tracking the order of the instructions, since instructions or operations may have different characteristics of power consumption signals in a processor.

For example, in the case of an elliptic curve cryptosystem, an operation of doubling the same point may have different consumption power. SPA may be tried by recognizing the characteristics of power that is consumed when such an operation instruction is executed.

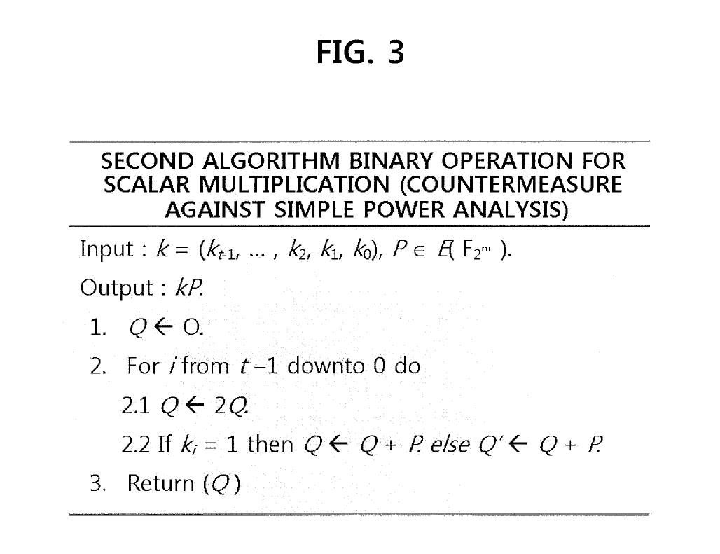

As a countermeasure against SPA, a method of elliptic curve cryptography according to a second algorithm as shown in FIG. 3 has been proposed.

FIG. 3 is an example of a second algorithm, which is a countermeasure against simple power analysis, and shows a binary operation for scalar multiplication.

First, an operation of summing the same point P k times is scalar multiplication for a point. The operation is, as described above, represented as kP, and is a basic operation in the elliptic curve cryptosystem. Scalar multiplication for an addition group consisting of points on an elliptic curve is similar to exponentiation for a fixed modulus in a multiplication group of integers.

kP may be calculated by doubling and addition using binary representation of an integer k, and the doubling and addition are similar to squaring and multiplication for exponentiation.

First, a k value and a P value corresponding to a point on an elliptic curve are received as input values. The P value corresponds to a point on an elliptic curve defined by E(F2^{m}). In this case, an output value is Q=kP.

The k value is a secret key, and k=(kₜ₋₁, . . . , k₂k₁, k₀). k_{t-1 j}is the most significant bit of k, and k is a binary value. That is, k may be represented by

$$k = {\sum }_{i = 0}^{t - 1} {k}_{i} {2}^{i} ,$$

wherein di ∈ {0, 1}.

The next process proceeds as follows.

In a first operation, an initial value is applied to Q (Q←0).

In a second operation, the following two steps proceed for i from t−1 down to 0.

First, the Q value is doubled to obtain a new Q value (Q←2Q).

Successively, it is determined whether kᵢ is 1, if kᵢ=1, Q+P is applied to Q (Q←Q+P), and if kᵢ≠1, Q+P is applied to Q′ (Q′←Q+P).

Here, the 2Q and Q+P values are calculated by doubling and addition performed on an elliptic curve, as shown in the first algorithm.

According to the elliptic curve cryptography as shown in the second algorithm, if kᵢ≠1, the elliptic curve point addition is performed as a dummy operation and stored in Q′. In this case, the stored Q′ is a dummy operation that is not used in an actual operation. A dummy operation is used as means for supporting an actual operation.

Although elliptic curve cryptography such as the second algorithm is simple, it requires a long computation time. Also, upon a dummy operation, the elliptic curve cryptography as shown in the second algorithm has a disadvantage that a secret key value may be analyzed when a fault injection attack is attempted to determine that there is no change in the result of elliptic curve cryptography. In other words, since the result of fault injection when a dummy operation is performed will be different from the result of fault injection when a Q value is substantially stored, and the Q value is stored when kᵢ=1, it can be determined that when the result of fault injection that is different from the result of fault injection when kᵢ≠1 appears, the corresponding value is a secret key.

According to an embodiment of the present invention, a method for elliptic curve cryptography capable of overcoming the problems of elliptic curve cryptography as shown in the first and second algorithms, that is, the problems that they are vulnerable to simple power analysis and fault injection analysis, is proposed.

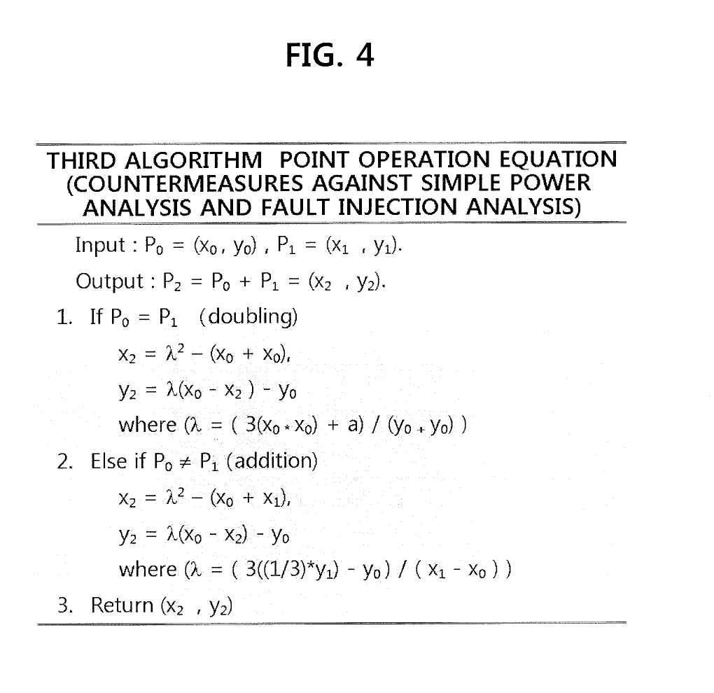

Hereinafter, a method for elliptic curve cryptography according to an embodiment of the present invention will be described with reference to FIG. 4.

FIG. 4 is an example of a third algorithm for elliptic curve cryptography according to an embodiment of the present invention.

First, two points P₀ and P₁ on an elliptic curve are defined as P₀=(x₀, x₀)≠0 and P₁=(x₁, y₁)≠0. Also, a sum P₂ of P₀ and P₁ is defined as P₂=(x₂, y₂).

In other words, input values are P₀=(x₀, y₀) and P₁=(x₁, y₁), and an output value is P₂=P₀+P₁=(x₂, y₂)

If P₀=P₁, x₂ and y₂ have the following values through point doubling.

x₂=λ²−(x₀+x₀) and y₂=λ(x₀−x₂)−y₀, wherein λ=(3(x₀*x₀)+a)/(y₀+y₀).

If P₀≠P₁, x₂ and y₂ have the following values through point addition.

x₂=λ²−(x₀+x₁) and y₂=λ(x₀−x₂)−y₀, wherein λ=(3((⅓)*y₁)−y₀)(x₁−x₀).

In the elliptic curve cryptography according to the current embodiment, the computation quantity of point addition is equal to the computation quantity of point doubling.

Since simple power analysis is based on the difference in computation quantity between operations, such as addition, multiplication, and division, etc., the algorithm for the elliptic curve cryptography according to the current embodiment removes the differences in computation quantity regarding addition, multiplication, and division between point addition and point doubling. In view of simple power analysis, the computation quantity of addition for two points is equal to the computation quantity of subtraction for the points.

In detail, when λ is calculated, its numerator is calculated through one multiplication, a threefold multiplication (×3) and one addition.

In more detail, for example, when λ is calculated, in the case of doubling, the numerator of λ becomes (x₀*x₀) through one multiplication, becomes 3(x₀*x₀) through a threefold multiplication, and finally becomes (3(x₀*x₀)+a) through one addition.

When λ is calculated, in the case of addition, the numerator of λ becomes ((⅓)*y₁) through one multiplication, becomes 3((⅓)*y₁) through a threefold multiplication, and finally becomes (3((⅓)*y₀)−y₀) through one subtraction, wherein the computation quantity of subtraction is equal to the computation quantity of addition, as described above. Here, (⅓) is a value calculated by a preceding operation and stored in advance in GF(p).

Also, when λ is calculated, its denominator is calculated through one addition in the case of doubling, and in the case of addition, the denominator is calculated through one subtraction. Accordingly, when λ is calculated, doubling and addition have the same computational quantity with respect to denominator.

In the addition of the method for elliptic curve cryptography according to the current embodiment only 3((⅓)*y₁) that is calculated in addition is added when λ is calculated, compared to the first algorithm. Such addition of 3((⅓)*y₁) adds a significantly small computation quantity compared to conventional methods for simple power analysis.

Also, since the method for elliptic curve cryptography according to the current embodiment includes no dummy operation compared to the second algorithm, it is impossible to analyze a secret key based on the result values of a fault injection attack.

Hereinafter, a system for elliptic curve cryptography, according to an embodiment of the present invention, will be described.

First, the system for elliptic curve cryptography may include a memory and a processor.

The memory stores the third algorithm corresponding to the method for elliptic curve cryptography, as shown in FIG. 3.

The processor unit loads the third algorithm from the memory, and creates and provides a code according to an input value using the third algorithm.

In other words, the system for elliptic curve cryptography includes the processor that loads the third algorithm from the memory storing the third algorithm and creates a code according to an input value using the third algorithm.

As described above, the method for elliptic curve cryptography makes the computation quantity of doubling that is used upon calculation with respect to the same point equal to the computation quantity of addition that is used upon calculation with respect to different points.

Also, since an operation that is added to make the computation quantity of doubling equal to the computation quantity of addition is very simple, an increase in computation time is minimized.

In addition, the method for elliptic curve cryptography provides a countermeasure against a side channel attack through simple power analysis by removing the difference in consumption power generated upon operation.

Furthermore, the method for elliptic curve cryptography also provides a countermeasure against fault injection analysis by removing a dummy operation.

While the example embodiments of the present invention and their advantages have been described in detail, it should be understood that various changes, substitutions and alterations may be made herein without departing from the scope of the invention.

What is claimed is:

1. A method for elliptic curve cryptography, in which an elliptic curve point operation is performed to generate an elliptic curve code, comprising:
receiving a first point and a second point on the elliptic curve, wherein the first point is P₀=(x₀, y₀) and the second point is P₁=(x₁, y₁); and
performing doubling if the first point is the same as the second point, and performing addition if the first point is different from the second point, to thereby obtain a third point, wherein the third point is P₂=P₀+P₁=(x₂, y₂).

2. The method of claim 1, wherein a computation quantity of the doubling is equal to a computation quantity of the addition.

3. The method of claim 1, wherein a dummy operation supporting an actual operation is removed from the doubling and the addition.

4. The method of claim 1, wherein x₂=λ²−(x₀+y₀) and y₂=λ(x₀−x₂)−y₀ when the doubling is performed, and x₂=λ²−(x₀+x₁) and y₂=λ(x₀−x₂)−y₀ when the addition is performed.

5. The method of claim 1, wherein, in the doubling and the addition, λ is obtained by one multiplication, a threefold multiplication (×3), and one addition or one subtraction.

6. The method of claim 5, wherein λ is (3(x₀*x₀)+a)/(y₀+y₀) if the doubling is performed, and λ is (3((⅓)*y₁)−y₀)/(x₁−x₀) if the addition is performed.

7. The method of claim 6, wherein, in λ of the addition, ⅓ is a value calculated in a preceding operation and stored in advance.

8. A system for elliptic curve cryptography, which performs an elliptic curve point operation to generate an elliptic curve code, comprising:
a memory configured to store a program code for performing an elliptic curve cryptography algorithm; and
a processor configured to load and use the program code to obtain a third point corresponding to a received first point and a received second point, wherein the first point is P₀=(x₀, y₀), the second point is P₁=(x₁, y₁), and the third point is P₂=P₀+P₁=(x₂, y₂); and
wherein the elliptic curve cryptography algorithm is configured to perform doubling if the first point is the same as the second point, and perform addition if the first point is different from the second point, to thereby obtain the third point.

9. The system of claim 8, wherein a computation quantity of the doubling is equal to a computation quantity of the addition.

10. The system of claim 8, wherein a dummy operation supporting an actual operation is removed from the doubling and the addition.

11. The system of claim 8, wherein x₂=λ²−(x₀+y₀) and y₂=λ(x₀−x₂)−y₀ when the doubling is performed, and x₂=λ²−(x₀+x₁) and y₂=λ(x₀−x₂)−y₀ when the addition is performed.

12. The system of claim 8, wherein, in the doubling and the addition, λ is obtained by one multiplication, a threefold multiplication (×3), and one addition or one subtraction.

13. The system of claim 12, wherein λ is (3(x₀*x₀)+a)/(y₀+y₀) if the doubling is performed, and λ is (3((⅓)*y₁)−y₀)/(x₁x₀) if the addition is performed.

14. The system of claim 13, wherein, in λ of the addition, ⅓ is a value calculated in a preceding operation and stored in advance.
